(19) United States
(12) Patent Application Publication
(10) Pub. No.: US 2023/0264956 A1
(43) Pub. Date: Aug. 24, 2023

(54) INTEGRATED PARTIAL OXIDATION AND ELECTROLYSIS PROCESS

(71) Applicant: GTI ENERGY, DES PLAINES, IL (US)

(72) Inventor: Zaher EL ZAHAB, Orlando, FL (US)

(73) Assignee: GTI ENERGY, DES PLAINES, IL (US)

(21) Appl. No.: 18/107,628

(22) Filed: Feb. 9, 2023

Related U.S. Application Data
(60) Provisional application No. 63/311,554, filed on Feb. 18, 2022.

(51) Int. Cl. C01B 3/48; C01B 3/36; B01J 19/24; B01J 19/00; C25B 1/04; C25B 15/08; C25B 9/65

(52) U.S. Cl. CPC C01B 3/48; C01B 3/363; B01J 19/245; B01J 19/0013; C25B 1/04; C25B 15/081; C25B 15/083; C25B 15/085; C25B 9/65; B01J 2219/00157; C01B 2203/0255; C01B 2203/0244; C01B 2203/0283; C01B 2203/1241; C01B 2203/1247; C01B 2203/0811; C01B 2203/0877; C01B 2203/84

(57) ABSTRACT

A system and method for producing hydrogen and/or power at scale. A partial combustion of a carbonaceous gaseous and/or liquid feed with an oxygen-containing feed generates heat for pyrolyzing non-combusted carbonaceous gaseous and/or liquid feed materials to produce an effluent including hydrogen, carbon monoxide, carbon dioxide, water, and nitrogen. Electrolysis powered by a renewable energy source converts water to hydrogen and oxygen for the oxygen-containing feed. Hydrogen is collected from the electrolysis, and also from the effluent, and sent to a hydrogen-based power generator.

### CROSS REFERENCE TO RELATED APPLICATION

This application claims the benefit of U.S. Provisional Patent Application, Ser. No. 63/311,554, filed on 18 Feb. 2022. The co-pending provisional application is hereby incorporated by reference herein in its entirety and is made a part hereof, including but not limited to those portions which specifically appear hereinafter.

### BACKGROUND OF THE INVENTION

### Field of the Invention

This invention relates generally to integrated partial oxidation and electrolysis processes, and more particularly to the integration of these process to produce hydrogen and/or power.

### Description of Prior Art

Electrolysis-based green hydrogen production systems driven by pure renewable power (i.e., wind, solar, hydro, etc.) require capital costs that are significantly higher than fossil-based blue hydrogen technologies to produce hydrogen and electric power at scale.

It is desirable to bring down the capital expenditures required for electrolysis-based green hydrogen systems by developing an integrated green and blue hydrogen approach such as described herein. This green/blue hydrogen systems integration concept will lower the financial risk for clean hydrogen projects and as such will also attract more capital investments to develop those projects.

### SUMMARY OF THE INVENTION

The invention generally relates to an integrated partial oxidation and electrolysis process intended to produce hydrogen at scale. The produced hydrogen may be used for power generation or stored for transmission and/or other uses.

The subject invention provides an integrated green and blue hydrogen approach to produce hydrogen and electric power at scale. The subject system preferably combines electrolysis, partial oxidation, and power generation processes.

The invention includes an integrated oxidation and electrolysis system for producing hydrogen and/or power at scale. Embodiments of this invention include a system including a partial oxidation reactor to partially combust a carbonaceous gaseous and/or liquid feed with oxygen to generate heat used to pyrolyze a non-combusted portion of the carbonaceous gaseous and/or liquid feed and create an effluent containing hydrogen, carbon monoxide, carbon dioxide, water, nitrogen, and other trace components. The system further includes an electrolyzer to convert water to hydrogen and oxygen, whereby the oxygen is fully or partially utilized as the oxygen for the partial oxidation reactor. The system further includes an electric power source, preferably renewable, that provides power input to the electrolysis process.

In embodiments of this invention, the system includes or is combined with a power plant that utilizes, fully or partially, a combined hydrogen feed produced collectively by the partial oxidation and electrolyzer, to generate electric power. In addition, heat from the electrolyzer and/or effluent processing can be feed to the power plant.

In embodiments of this invention, the partial oxidation reactor is embodied as or within an auto-thermal reformer.

In embodiments of this invention, an oxygen feed line is configured to transport all of the oxygen from the electrolyzer to the partial oxidation reactor. An oxygen storage apparatus, such as a storage tank, can be used in combination with the oxygen feed to store excess or all produced oxygen until needed. Similarly, one or more hydrogen storage apparatuses can be used at various points in the system.

In embodiments of this invention, a quench water feed is used in combination with the partial oxidation reactor, such as downstream of a partial oxidation reaction zone where the carbonaceous gaseous and/or liquid feed is combusted. The quench water feed is configured to cool the effluent and can then be combined with the effluent to increase a total water content of the effluent.

In embodiments of this invention, the effluent is further processed to produce additional hydrogen from hydrogen-containing components. For example, a water-gas-shift reaction can be used to react carbon monoxide and water in the effluent to produce the additional hydrogen. The heat from this reaction can also be used in the system or the power plant. Any suitable mechanism or process, such as a separator and/or purifier apparatus, can be used to separate hydrogen from the effluent or from effluent components.

The invention further includes a method for producing hydrogen and/or power at scale. The method includes steps of: combusting in a reactor a carbonaceous gaseous and/or liquid feed with an oxygen-containing feed to generate heat; pyrolyzing non-combusted carbonaceous gaseous and/or liquid feed materials to produce an effluent including hydrogen, carbon monoxide, carbon dioxide, water, and nitrogen; converting water to hydrogen and oxygen by electrolysis; and feeding the oxygen from the electrolysis within the oxygen-containing feed to the reactor.

The method desirably further includes feeding the hydrogen to a power generator/plant. Preferably the power plant uses a combined hydrogen produced by both the partial oxidation and electrolysis to generate electric power. Heat from the reactions in the system can also be applied to the power plant.

In embodiments of this invention, the method includes storing at least one of: oxygen from the electrolysis, or hydrogen from the electrolysis and/or the combusting.

In embodiments of this invention, the method includes cooling the effluent with water and/or increasing a total water content of the effluent.

In embodiments of this invention, the method includes reacting the effluent in a water-gas-shift reaction or reactor to produce additional hydrogen. The hydrogen can be separated and/or purified from the effluent or from other effluent components.

As shown and described in more detail below, the subject invention creates a link between an electrolysis process and a partial oxidation process to maximize the production of hydrogen (H2). The link is created by entirely consuming the electrolysis oxygen byproduct in a partial oxidation process that utilizes carbonaceous gaseous and/or liquid feedstocks to produce hydrogen-containing effluent. Ultimately, the hydrogen produced by partial oxidation and electrolysis is combined to feed the power plant process and/or stored for further transmission and/or other uses. When the electrolysis is powered by a renewable energy source, such as biomass, solid waste, wind, solar, wave, hydroelectric, and/or geothermal power systems, the system provides a desirable combined green-blue hydrogen production.

Other objects and advantages will be apparent to those skilled in the art from the following detailed description taken in conjunction with the appended claims and drawings.

### BRIEF DESCRIPTION OF THE DRAWINGS

FIG. 1 shows a schematic of the subject system according to one embodiment of this invention.

FIG. 2 shows a schematic of the subject system according to one embodiment of this invention.

### DETAILED DESCRIPTION OF THE INVENTION

The present invention provides an integrated partial oxidation and electrolysis system and process intended to produce hydrogen at scale.

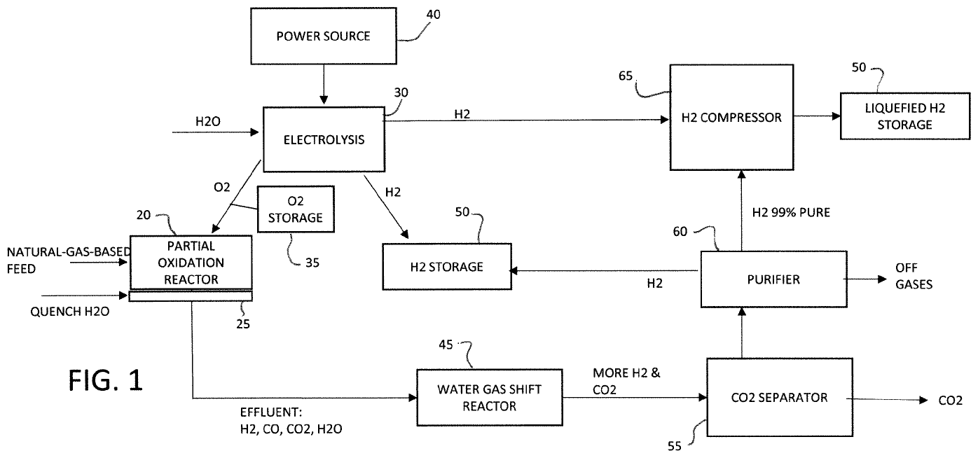

As best shown in FIG. 1, one embodiment of the subject invention preferably includes one or more partial oxidation reactor(s) 20 that partially combusts one or more carbonaceous gaseous and/or liquid feed(s). The carbonaceous gaseous and/or liquid feed(s) can be any suitable material such as natural gas, refinery off-gases, liquified-petroleum gases, pyrolysis gases, renewable gases, and combinations thereof. As illustrated, a natural gas feed is combined and combusted with at least one oxygen-containing feed to generate heat. The heat is used to pyrolyze the non-combusted carbonaceous gaseous and/or liquid feed materials and create an effluent containing hydrogen, carbon monoxide (CO), carbon dioxide (CO2), water (H2O), nitrogen (N2), as well as containing varying other trace components.

One or more electrolyzer(s) 30 are preferably utilized upstream of the reactor(s) 20 and serve to convert water (H2O) to hydrogen (H2) and oxygen (O2). One or more electric power sources 40 provides power input to the electrolyzer(s) 30 to realize the electrolysis process. Any power source can be used, but in embodiments the power source is or includes a renewable energy source, such as selected from biomass, solid waste, wind, solar, wave, hydroelectric, and/or geothermal power systems, or combinations thereof. Alternatively, or in addition, the electric power source 40 for electrolysis may come from battery storage, and/or nuclear, and/or fossil fuel sources. Alternatively, or in addition, the electric power source 40 for electrolysis may come from the power grid.

Produced hydrogen is preferably passed through a compressor 65 where it may be stored as gaseous or liquified hydrogen in storage facilities 50, and thereafter used as needed or desired. Although shown as a single storage facility 50 in FIG. 1, combined and/or separate storage facilities 50 may be used to store the H2 produced by both the partial oxidation and electrolysis.

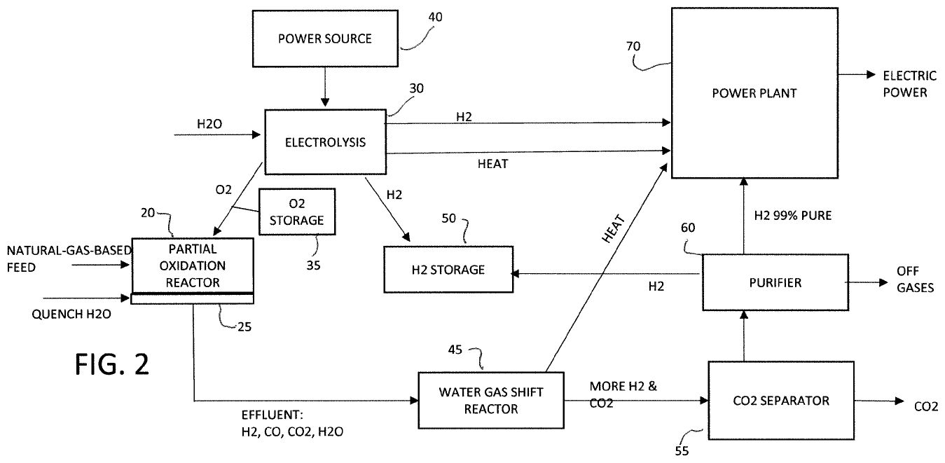

FIG. 2 shows an additional embodiment of the subject invention wherein an integrated partial oxidation, electrolysis, and power generation process produces electric power from the produced hydrogen. As shown in FIG. 2, and like in the embodiment shown in FIG. 1, the subject system includes one or more partial oxidation reactor(s) 20 that partially combusts carbonaceous gaseous and/or liquid feed materials with an oxygen-containing feed to generate heat that is used to pyrolyze the non-combusted portion of the carbonaceous gaseous and/or liquid feed to create an effluent containing hydrogen, carbon monoxide (CO), carbon dioxide (CO2), water (H2O), nitrogen (N2) and other trace components. One or more electrolyzer(s) 30 are positioned relative to the reactors 20 and are fed by one or more power sources 40 that serve to convert water (H2O) to hydrogen (H2) and oxygen (O2). As further shown in FIG. 2, a power plant 70 positioned downstream of the hydrogen production system, uses, fully or partially, the combined hydrogen produced from both the partial oxidation and the electrolysis to generate electric power.

In a preferable embodiment of the subject invention, the electrolyzer(s) 30 provide(s) the full oxygen feed to the partial oxidation reactor 20. Likewise, all oxygen produced by electrolysis is desirably entirely utilized by the partial oxidation process. In embodiments of the subject system, the heat release from electrolysis is recovered and utilized as heat input to the power plant 60.

Effluent from the partial oxidation reactor 20 may be cooled by injecting quench water 25 directly inside the partial oxidation reactor 20, preferably directly downstream of a partial oxidation reaction zone therein. In addition to cooling, the quench water 25 can be used to increase the overall water content of the partial oxidation effluent.

As shown in the figures, the partial oxidation effluent may pass directly from the partial oxidation reactor 20 through a water-gas-shift reactor 45 to maximize the production of hydrogen by reacting the partial oxidation effluent carbon monoxide and water contents, such as according to the following forward reaction: CO+H2O→CO2+H2. Heat released from this water-gas-shift reaction may be recovered and utilized as heat input to the power plant, as shown in FIG. 2.

In the subject system, a separation and/or purification mechanism such as a separator 55 and purifier 60 may be included to separate/remove CO2, CO and other traces from the partial oxidation effluent and/or the resulting hydrogen.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. An integrated oxidation and electrolysis system for producing hydrogen and/or power at scale, the system comprising:
a partial oxidation reactor to partially combust a carbonaceous gaseous and/or liquid feed with oxygen-containing feeds to generate heat used to pyrolyze a non-combusted portion of the carbonaceous gaseous and/or liquid feed and create an effluent containing hydrogen, carbon monoxide, carbon dioxide, water, nitrogen, and other trace components;
an electrolyzer to convert water to hydrogen and oxygen, whereby the oxygen is fully or partially utilized as an oxidizer for the partial oxidation reactor; and
an electric power source that provides power input to the electrolysis process.

2. The system of claim 1, further comprising a power plant that utilizes, fully or partially, a combined hydrogen feed produced collectively by the partial oxidation and electrolyzer, to generate electric power.

3. The system of claim 2, wherein heat from the electrolyzer is feed to the power plant.

4. The system of claim 1, wherein the partial oxidation reactor is embodied in an auto-thermal reformer.

5. The system of claim 1, further comprising an oxygen feed configured to transport all of the oxygen from the electrolyzer to the partial oxidation reactor.

6. The system of claim 5, further comprising an oxygen storage apparatus in combination with the oxygen feed.

7. The system of claim 1, further comprising at least one hydrogen storage apparatus in combination with at least one of the partial oxidation reactor and the electrolyzer.

8. The system of claim 1, further comprising a quench water feed in combination with the partial oxidation reactor and downstream of a partial oxidation reaction zone therein, wherein the quench water feed is configured to cool the effluent and increase a total water content of the effluent.

9. The system of claim 1, further comprising a water-gas-shift reactor configured to receive the effluent from the partial oxidation reactor, wherein the water-gas-shift reactor is configured to react carbon monoxide and water in the effluent to produce additional hydrogen.

10. The system of claim 1, further comprising a separator and/or purifier apparatus to separate hydrogen from the effluent or from effluent components.

11. The system of claim 1, wherein the power source comprises a renewable energy source selected from biomass, solid waste, wind, solar, wave, hydroelectric, and/or geothermal power systems.

12. The system of claim 1, wherein the carbonaceous gaseous and/or liquid feed comprises natural gas, refinery off-gases, liquified-petroleum gases, pyrolysis gases, renewable gases, and combinations thereof.

13. A method for producing hydrogen and/or power at scale, the method comprising:
combusting in a reactor a carbonaceous gaseous and/or liquid feeds with an oxygen-containing feed to generate heat;
pyrolyzing non-combusted carbonaceous gaseous and/or liquid feed materials to produce an effluent including hydrogen, carbon monoxide, carbon dioxide, water, and nitrogen;
converting water to hydrogen and oxygen by electrolysis; and
feeding the oxygen from the electrolysis within the oxygen-containing feed to the reactor.

14. The method of claim 13, further comprising feeding the hydrogen to a power plant, wherein the power plant uses a combined hydrogen produced by both the partial oxidation and electrolysis to generate electric power.

15. The method of claim 13, further comprising feeding heat from the electrolysis to the power plant.

16. The method of claim 13, further comprising storing at least one of: oxygen from the electrolysis, or hydrogen from the electrolysis and/or the combusting.

17. The method of claim 13, further comprising cooling the effluent with water and increasing a total water content of the effluent.

18. The method of claim 13, further comprising reacting the effluent in a water-gas-shift reactor to produce additional hydrogen.

19. The method of claim 18, further comprising separating and/or purifying hydrogen from the effluent or other effluent components.

20. The method of claim 13, further comprising powering the electrolysis with a renewable energy source selected from biomass, solid waste, wind, solar, wave, hydroelectric, and/or geothermal power systems.
